(19) United States
(12) Patent Application Publication
(10) Pub. No.: US 2010/0183038 A1
(43) Pub. Date: Jul. 22, 2010

(54) Magnetic damping of tuning arm in an external cavity laser

(75) Inventors: Lam Le, Fremont, CA (US); Weizhi Wang, Palo Alto, CA (US)

Correspondence Address: NEWPORT CORPORATION, 1791 DEERE AVENUE, IRVINE, CA, 92606, US

(73) Assignee: Newport Corporation, Irvine, CA (US)

(21) Appl. No.: 12/657,398

(22) Filed: Jan. 19, 2010

Related U.S. Application Data
(60) Provisional application No. 61/145,465, filed on Jan. 16, 2009.

(51) Int. Cl. H01S 3/10

(52) U.S. Cl. 372/20

(57) ABSTRACT

The present application is directed to a tuning arm system for use in a tunable external cavity diode laser system and includes a tuning arm body, at least one prism support coupled to the tuning arm body, at least one component support coupled to the prism support and configured to support at least one optical component therein, the component support manufactured from a magnetic material, and at least one magnetic device positioned proximate to the component support.

### CROSS REFERENCE TO RELATED APPLICATIONS

The present application claims priority to U.S. Provisional Patent Application Ser. No. 61/145,465, Jan. 16, 2009, the contents of which are hereby incorporated by reference in its entirety herein.

### BACKGROUND

Tunable external cavity diode lasers (ECDL) are used in a variety of applications. For example, the compact size of ECDL devices and ability to easily vary the output wavelength have resulted in the inclusion of these devices in numerous spectroscopy systems. Generally, tuning of the output wavelength is accomplished by changing the cavity length by a moving diffraction grating or filter. For example, U.S. Pat. No. 7,388,890 (hereinafter '890 patent) describes a system wherein one end of the external cavity of a diode laser system is formed by a moving prism positioned on a pivot point device. During use, movement of the prism device permits a user to vary the cavity length and select the desired wavelength. For manufacturability, the prism is typically positioned by a cantilever structure as described in the '890 patent or a rigid pivot point structure as described in U.S. Pat. No. 5,995,521 (hereinafter '521 patent).

FIGS. 1-3 show various view of a prior art tuning arm system used to support a prism for use in an ECDL. As shown, the tuning arm system 1 includes a tuning arm body 3 having a prism holder 5 coupled thereto. The prism holder 5 is configured to have a prism 7 coupled thereto via an adhesive 9. Further, the prism holder includes one or more fastener orifices 11 enabling the prism holder 5 to be coupled to the tuning arm body 3.

While both the cantilever design disclosed in the '890 patent and the rigid structure design disclosed in the '521 patent have proven useful in the past, a number of shortcomings of each design have been identified. For example, the cantilever design of the '890 patent includes a bearing tuning arm which supports and positions the prism. During use, the tuning arm may oscillate when excited by external acoustic perturbations. As a result, the oscillation of the tuning arm, and the prism supported thereby, may result in an undesirable variation or jitter of the output wavelength of the tunable laser.

Thus, in light of the foregoing, there is an ongoing need for a tuning arm system for use in ECDL systems capable of damping external acoustic perturbations.

### SUMMARY

The devices described in the present application meet these and other needs by providing a tuning arm system capable of stably positioning an optical component at a desired position within a ECDL laser system thereby permitting the precise control of the output wavelength of the laser.

In one embodiment, the present application is directed to a tuning arm system for use in a tunable external cavity diode laser system and includes a tuning arm body, at least one prism support coupled to the tuning arm body, at least one component support coupled to the prism support and configured to support at least one optical component therein, the component support manufactured from a magnetic material, and at least one magnetic device positioned proximate to the component support.

In another embodiment, the present application is directed to a tuning arm system for use in a tunable external cavity diode laser system and includes a tuning arm body, at least one prism support coupled to the tuning arm body, the prism support manufactured from a magnetic material, at least one component support coupled to the prism support and configured to support at least one optical component therein, and at least one magnetic device positioned proximate to the prism support and component support.

Other features and advantages of the embodiments of the magnetic dampened tuning arm system as disclosed herein will become apparent from a consideration of the following detailed description.

### BRIEF DESCRIPTION OF THE DRAWINGS

Various embodiments of a magnetic dampened tuning arm system will be explained in more detail by way of the accompanying drawings, wherein:

FIG. 1 shows a perspective view of a prior art tuning arm system for use in an ECDL system, the tuning arm supporting a prism;

FIG. 2 shows a perspective view of a prior art tuning arm system for use in an ECDL system, the tuning arm having a prism detached therefrom;

FIG. 3 shows a perspective view of a prior art prism support used with the tuning arm system of FIGS. 1 and 2;

FIG. 4 shows a perspective view of an embodiment of a novel tuning arm system for use in an ECDL laser system;

FIG. 5 shows a side view of an embodiment of a novel tuning arm system for use in an ECDL laser system wherein a magnetic device if positioned proximate to the component support positioned on the prism support;

FIG. 6 shows a perspective view of an embodiment of a prism support for use with the tuning arm system of FIGS. 4 and 5;

FIG. 7 shows a exploded perspective view of an embodiment of a tuning arm body of a tuning arm system being coupled to a foundation for use in an ECDL laser system;

FIG. 8 shows a exploded perspective view of an embodiment of a prism support of a tuning arm system being coupled to a foundation for use in an ECDL laser system; and

FIG. 9 shows a top view of an embodiment of a prism support of a tuning arm system being coupled to a foundation for use in an ECDL laser system.

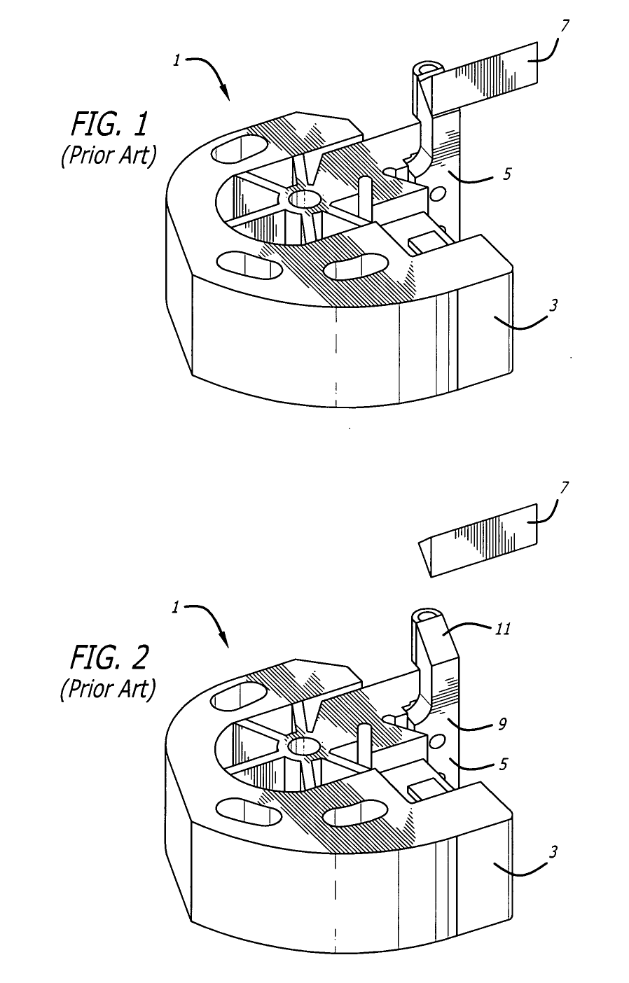

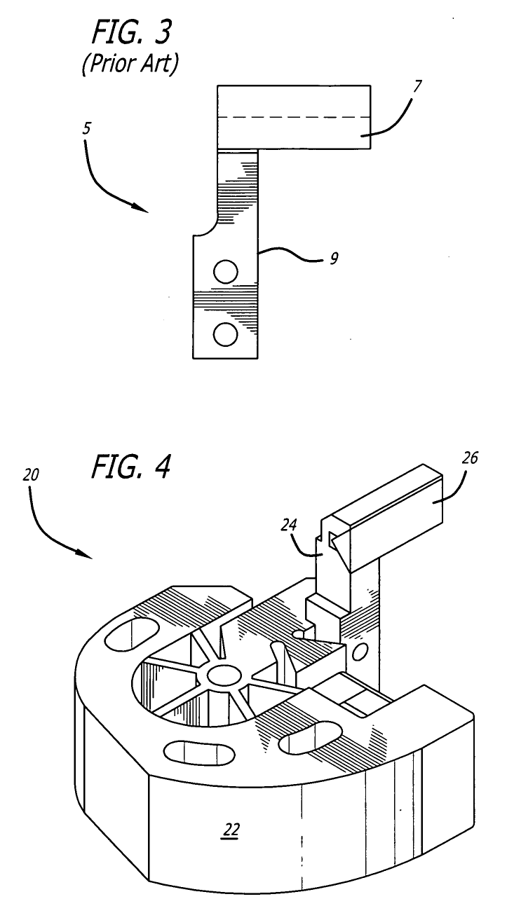

### DETAILED DESCRIPTION

FIGS. 4-6 show various views of an embodiment of a tuning arm system for use with an ECDL system. As shown, the tuning arm system 20 includes a tuning arm body 22 configured to have at least one prism support 24 coupled thereto. In one embodiment, the tuning arm body 22 is constructed from stainless steel. Optionally, the tuning arm body 22 may be manufactured from any variety of materials, including, without limitations, aluminum, titanium, steel, copper, copper tungsten, brass, metallic alloys, silica, various composite materials, carbon fiber, Zerodur™, ceramic, ceramic composites, polymers, and the like.

Like the tuning arm body 22, the prism support 24 may be manufactured from any variety of materials. In one embodiment, the prism support 24 is manufactured from a magnetic material. For example, the prism support 24 may be manufactured from steel. In another embodiment, the prism support 24 is manufactured from a magnetic metallic alloy. In still another embodiment, the prism support 24 is manufactured from a polymer which incorporates magnetic materials therein. Optionally, the prism support 24 may be manufactured from any variety of materials, including, without limitations, titanium, steel, copper, copper tungsten, brass, metallic alloys, silica, various composite materials, carbon fiber, Zerodur™, ceramic, ceramic composites, polymers, and the like. In the illustrated embodiment, the prism support 24 is detachably coupled to the tuning arm body 22. In an alternate embodiment, the prism support 24 may non-detachably coupled to tuning arm body 22. At least one prism 26 is supported by the prism support 24. Those skilled in the art will appreciate that the prism support 24 may be configured to support any variety of optical components, including, without limitations, lenses, filters, polarizers, beam splitters, holographic optical elements, volume Bragg gratings, Bragg gratings, and the like.

Referring again to FIGS. 4-6, the prism support 24 includes one or more component support bodies 28 coupled thereto. In one embodiment, the component support body 28 is non-detachably coupled to the prism support 24. For example, the component support body 28 may be integral to the prism support 24. In another embodiment, the component support body 28 is adhesively coupled to the prism support 24. Optionally, the component support body 28 may be welded or brazed to the prism support 24. In another embodiment, the component support body 28 is detachably coupled to the prism support 24. The component support 28 may be manufactured from a magnetic material. For example, the component support 28 may be manufactured from steel. In another embodiment, the component support 28 is manufactured from a magnetic metallic alloy. In still another embodiment, the component support 28 is manufactured from a polymer which incorporates magnetic materials therein. Optionally, the component support 28 may be manufactured from any variety of materials, including, without limitations, titanium, steel, copper, copper tungsten, brass, metallic alloys, silica, various composite materials, carbon fiber, Zerodur™, ceramic, ceramic composites, polymers, and the like. Optionally, a magnetic device may be positioned on or integrated into the component support 28.

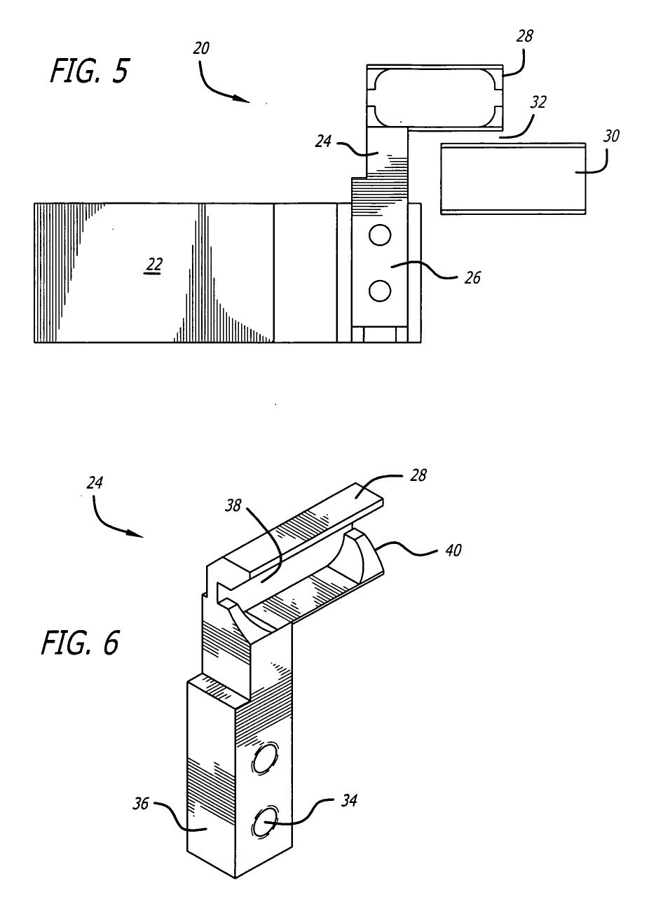

As shown in FIG. 5, during use at least one magnetic device 30 may be positioned proximate to component support 28. In one embodiment, the magnetic device 30 comprises a rare earth magnet. In the alternative, any variety of devices capable of emitting a magnetic field may be used, including, electro-magnets, rare earth magnets, and the like. As shown, the magnetic device 30 is positioned proximate to but not in contact with the component support 28. As such, at least one passage 32 may be formed between the magnetic device 30 and the support body 28. During use, the passage 32 may remain unfilled. Optionally, one or more materials may be positioned within the passage 32. Exemplary materials include, without limitations, various adhesives, greases, filler materials, vaporless materials, and the like. Further, the magnetic device 30 may be in contact with the component support 28.

As shown in FIG. 6, the prism support 24 may include a prism support body 36 having one or more fastener recesses 34 formed therein. The fastener recesses 34 may be configured to receive one or ore fasteners therein, thereby permitting the prism support 24 to be detachably coupled to the tuning arm body 22 (See FIG. 5). Optionally, any variety of coupling features may be formed on the prism support body 36 and configured to permit the prism support 24 to be detachably coupled to the tuning arm body 22. For example, the prism support body 36 may include one or more dovetail features configured to engaged and retained by the tuning arm body 22. Optionally, any variety of coupling devices may be used to detachably couple the prism support 24 to the tuning arm body 22, including, without limitations, pins, screws, thread members, snap locks, frictions fits, and the like. In the alternative, the prism support 24 may be non-detachably coupled to the tuning arm body 22. For example, the prism support 24 may be coupled to the tuning arm body 22 using, without limitations, welds, solder joints, brazed joints, adhesive, bonding techniques, magnetic coupling, and the like.

Referring again to FIG. 6, the at least one aperture 38 may be formed within the component support 28. In one embodiment, the aperture 38 is configured to permit light to traverse therethrough. Optionally, the component support 28 may be manufactured without an aperture formed therein. Further, one or more component retaining devices 40 may be formed on the component support 28. In the illustrated embodiment, the component retaining device 40 comprises one or more surfaces configured to have at least one adhesive applied thereto and engage a component positioned there against. In another embodiment, the component retaining device 40 comprises at least one friction fit device. In short, any variety of component retaining devices 40 may be positioned on the component support 28 and configured to retain at least one component therein.

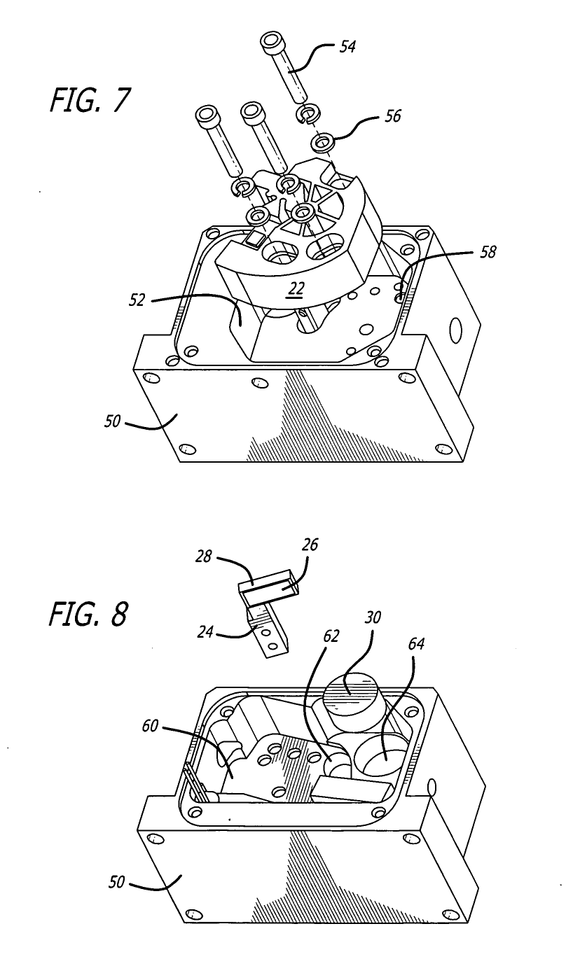

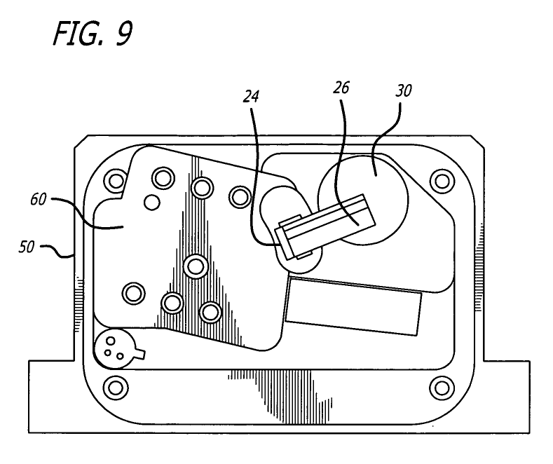

FIGS. 7-9 show various views of the tuning arm system shown in FIGS. 4-6 installed in a foundation for use in an ECDL system. As shown, the foundation 50 defines a tuning arm body orifice 52 sized to receive the tuning arm body 22 therein. During assembly, the tuning arm body 22 is positioned within the orifice 52 and one or more fasteners 54 and washers 56 are inserted through the tuning arm body 22 and configured to engage at least one fastener recess 58 located within the orifice 52 formed in the foundation 50. Those skilled in the art will appreciate that the tuning arm body 22 may be coupled to the foundation 50 using any variety of methods known in the art.

The foundation 50 may be turned over, thereby exposing at least one prism support orifice 60 formed in the foundation 50. The magnetic device 30 may be positioned within at least one magnetic device recess 64 formed in the prism support orifice 60. Those skilled in the art will appreciate that the magnetic device 30 may be retained within the magnetic device orifice 64 using any variety of materials, including, without limitations, adhesives, screws, and the like. Thereafter, the prism support 24 having a prism 26 coupled thereto may be inserted through the prism support passage 62 formed in the foundation 50 and coupled to the tuning arm body 22 positioned within the tuning arm body orifice 52.

During use, the magnetic materials forming at least one of the component support 28 and/or prism support 24 are located within the magnetic field generated by the magnetic device 30 positioned proximate to the component support 28, thereby damping the undesirable external acoustic perturbations of the prism 26. As such, the user may easily tailor the damping effects of the tuning arm system by replacing the magnetic device 30 with a magnetic device generating a greater or lesser magnetic force. In another embodiment utilizing an electromagnet as the magnetic device 30, the current provided to the magnetic device 30 may be increased or decreased to vary the strength of the generated magnetic field, thereby permitting the user to adjust the damping effect. In contrast to prior art systems, when supporting a wavelength selection device such as a prism or grating, the present system permits stable positioning of the wavelength control device thereby permitting precise control over the output wavelength of a tunable ECDL laser system.

While particular forms of embodiments have been illustrated and described, it will be apparent that various modifications can be made without departing from the spirit and scope of the embodiments of the invention. Accordingly, it is not intended that the invention be limited by the forgoing detailed description

What is claimed is:

1. A tuning arm system for use in a tunable external cavity diode laser system, comprising:
a tuning arm body;
at least one prism support coupled to the tuning arm body;
at least one component support coupled to the prism support and configured to support at least one optical component therein, the component support manufactured from a magnetic material; and
at least one magnetic device positioned proximate to the component support.

2. The device of claim 1 wherein the tuning arm body is manufactured from a ceramic material.

3. The device of claim 1 wherein the tuning arm body is manufactured from Zerodur™.

4. The device of claim 1 wherein the tuning arm body is manufactured from at least one material selected from the group consisting of aluminum, titanium, steel, copper, copper tungsten, brass, metallic alloys, silica, various composite materials, carbon fiber, ceramic composites, and polymers.

5. The device of claim 1 wherein the tuning arm is configured to be secured to a foundation of an ECDL system.

6. The device of claim 1 wherein the prism support is detachably coupled to the tuning arm body.

7. The device of claim 1 wherein the prism support is non-detachably coupled to the tuning arm body.

8. The device of claim 1 wherein the prism support is manufactured from a magnetic material.

9. The device of claim 1 wherein the prism support is manufactured from at least one selected from the group consisting of aluminum, titanium, steel, copper, copper tungsten, brass, metallic alloys, silica, composite materials, carbon fiber, Zerodur™, ceramic, ceramic composites, and polymers.

10. The device of claim 1 wherein the component support is detachably coupled to the prism support.

11. The device of claim 1 wherein the component support is non-detachably coupled to the prism support.

12. The device of claim 1 wherein the magnetic device comprises a rare earth magnet.

13. The device of claim 1 wherein the magnetic device comprises at least one electromagnet.

14. A tuning arm system for use in a tunable external cavity diode laser system, comprising:
a tuning arm body;
at least one prism support coupled to the tuning arm body, the prism support manufactured from a magnetic material;
at least one component support coupled to the prism support and configured to support at least one optical component therein; and
at least one magnetic device positioned proximate to the prism support and component support.

15. The device of claim 14 wherein the tuning arm body is manufactured from Zerodur™.

16. The device of claim 14 wherein the tuning arm body is manufactured from at least one material selected from the group consisting of aluminum, titanium, steel, copper, copper tungsten, brass, metallic alloys, silica, various composite materials, carbon fiber, ceramic composites, and polymers.

17. The device of claim 14 wherein the tuning arm is configured to be secured to a foundation of an ECDL system.

18. The device of claim 14 wherein the prism support is detachably coupled to the tuning arm body.

19. The device of claim 14 wherein the component support is detachably coupled to the prism support.

20. The device of claim 14 wherein the component support is non-detachably coupled to the prism support.

21. The device of claim 14 wherein the magnetic device comprises a rare earth magnet.
